(19) United States
(12) Patent Application Publication
(10) Pub. No.: US 2013/0091458 A1
(43) Pub. Date: Apr. 11, 2013

(54) ALBUM LIST MANAGEMENT SYSTEM AND METHOD IN MOBILE DEVICE

(71) Applicant: Ki Dong Kang, Seoul (KR)

(72) Inventor: Ki Dong Kang, Seoul (KR)

(73) Assignees: KIA MOTORS CORPORATION, Seoul (KR); HYUNDAI MOTOR COMPANY, Seoul (KR)

(21) Appl. No.: 13/313,726

(22) Filed: Dec. 7, 2011

(30) Foreign Application Priority Data
Oct. 5, 2011 (KR) 10-2011-0101213

(51) Int. Cl. G06F 3/048; G06F 17/30

(52) U.S. Cl. 715/784; 707/737; 707/E17.01

(57) ABSTRACT

Disclosed is an album list management system and method in mobile device which automatically classify files input to the terminal into a music file and a video file to effectively manage the files and perform index and reproduction of the files easily are provided. More specifically, files are inputted from an outside source, the input files are classified according to types of the files and stored in a memory, an album list is generated to be displayed for each classified file, and the generated album list is displayed on a display unit.

### CROSS-REFERENCES TO RELATED APPLICATIONS

The priority of Korean patent application No. 10-2011-0101213 filed on Oct. 5, 2011, the disclosure of which is hereby incorporated in its entirety by reference, is claimed.

### BACKGROUND OF THE INVENTION

1. Field of the Invention

The present invention relates to album list management system and method for implementation in mobile devices, and more particularly, to album list management system and method for implementation in mobile devices which automatically classifies files input into a terminal into a music file and a video file, and effectively manages the files and performs indexing and reproduction of the files easily.

2. Description of the Related Art

Generally, with development of recent technology, mobile terminals hereinafter referred to as a device or a terminal have become lighter, thinner, simpler and smaller in appearance and have been developed to perform various multimedia functions such as imaging a still or moving image, reproducing music or image files, or gaming, in addition to conventionally basic functions as a broadcasting reception apparatus or a communication apparatus, in response to consumer demand.

Terminals are divided into mobile terminals (or portable terminals) and stationary terminals according to their ability to be moved, and the mobile terminal is divided into a hand held terminal and a vehicle-mounted terminal according to whether or not the terminal can be easily taken in and out of the vehicle by a driver.

Navigation systems are one of these types of vehicle-mounted terminals. Navigation systems typically calculate the current position of a vehicle via a signal received from a satellite and calculate a route to a destination.

Some existing navigation systems include a function which reproduces multimedia contents such as music/video as well as a function to receive digital multimedia broadcasting (DMB), in addition to basic guidance function. These navigation systems are often provided with a touch screen user interface to further provide various functions and services to the driver. Thus, the navigation system is becoming an integrated multimedia apparatus in the vehicle.

As a result, the number of the files included in the terminal has increased and the kinds of the files included in the terminal are now diversified. Thus, when the file list is managed in one dimensional text type as is done in a conventional manner system, it takes a long time to find a user's desired file from the file list and often a dubious amount of selections and searching is required in order to find and execute the file. Thus, the user is inconvenienced.

Furthermore, safety is impaired. Therefore, equipment mounted on the vehicle should be simple and easy to manipulate and the equipment should not hinder the user's driving.

### SUMMARY OF THE INVENTION

Various aspects of the present invention have been made in view of the above problems, and provides an album list management system and method for implementation in mobile devices which automatically classifies files input to a terminal into a music file and/or a video file to effectively manage the files, intuitively selects and indexes built-in files, and easily performs checks and reproduction of the files.

According to an aspect of the present invention, an album list management method for managing files in a mobile device is provided. The method may include: inputting files from an outside source; classifying the input files according to types of files and storing the classified files; generating an album list to be displayed for each classified file; and displaying the generated album list on a display unit.

Furthermore, classifying and storing the files may include selectively classifying the input files into a video file and a music file and storing the classified files respectively. The classifying and storing the files may also include classifying the input files based on an extension type of the input files or a result searched through a network connectable to a terminal. The album list may be implemented with an album artwork of a corresponding album.

The display unit may include an input device in which information is inputted through contact with, e.g., a touch panel. The method may include flick-controlling the album list by a flick signal from a first reference point to a second reference point through the input device. Flick-controlling the album list may include controlling left and right scrolling of the album list by lateral directional flicking and controlling top and bottom scrolling of the album list by longitudinal directional flicking. The flick-controlling the album list may also include, with respect to an arbitrary album on the album list, performing a long touch on the display unit of the album to execute reproduction of the album.

According to still another aspect of the present invention, an album list management system in a mobile terminal providing a multimedia function is provided. The system may include: an input device configured to input files from an outside source; a memory configured to store the files input through the input device; a control unit configured to classify the files input through the input device for each type of the file and store the classified files in the memory.

The system may further include a display unit configured to arrange a music video file or a video file stored in the memory in a list of an album image type according to control of the control unit and display the list on a screen.

The input device may include any one selected from the group consisting of a wireless communication unit configured to perform connection to a wireless communication system, an audio/video (A/V) input unit configured to receive external video information and/or external audio information, and an interface configured to connect with an external apparatus, e.g., a flash drive, smart card, portable music player, cell phone, etc.

The display unit may include an input device configured to input information through contact with, e.g., a touch panel. The control unit may include a file selection module configured to select files inputted into the terminal by each type of file, and an input interpretation module configured to control scrolling of the album list based on a flick signal from a first reference point to a second reference point through the input device.

According to the exemplary embodiments of the present invention, a user can automatically classify files input to the terminal into video files and music files to effectively manage the classified files and manage and organize the files included in the terminal in an easily findable manner and thus the user can intuitively find a desired music file or video file even when driving or moving to reproduce the file through simple manipulation.

According to the system of the exemplary embodiment, it is possible to quickly search for a file by the user through intuitive display and screen output and to execute indexing or reproduction of the files through simple manipulation. Therefore, it is possible to provide safe and comfortable apparatus usage environments without dispersion of the user's attention when the driver in driving or moving.

The systems and methods of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a block diagram illustrating a configuration of an album list management system in a mobile terminal for vehicles according to an exemplary embodiment of the present invention.

FIG. 2 is a view illustrating an operation of a mobile terminal according to an exemplary embodiment of the present invention.

FIG. 3 is a view illustrating a method of classifying files according to an exemplary embodiment of the present invention.

FIG. 4 is a view illustrating an example of an index item search method according to an exemplary embodiment of the present invention.

FIG. 5 is a view illustrating an example of a sequenced item search method according to an exemplary embodiment of the present invention.

FIG. 6 is a view illustrating an example of an image in which a specific album selected by a user is output on a display screen cording to an exemplary embodiment of the present invention.

FIG. 7 is a view illustrating a case where the methods of FIGS. 4 and 5 are used.

FIGS. 8A to 8C are a view illustrating an example of an index item search method according to another exemplary embodiment of the present invention.

FIG. 9 is a sequence diagram illustrating a process of inputting files to a mobile device, automatically classifying the files, and reproducing the files according to an exemplary embodiment of the present invention.

### DETAILED DESCRIPTION

Reference will now be made in detail to various embodiments of the present invention(s), examples of which are illustrated in the accompanying drawings and described below. Like reference numerals in the drawings denote like elements. When it is determined that detailed description of a configuration or a function in the related disclosure interrupts understandings of embodiments in description of the embodiments of the invention, the detailed description will be omitted.

It should be understood that in a detail description below, as suffixes for configuration elements, ‘module’ and ‘unit’ are assigned or used together, for clarity, but there is no distinctive meaning or function between them per se.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

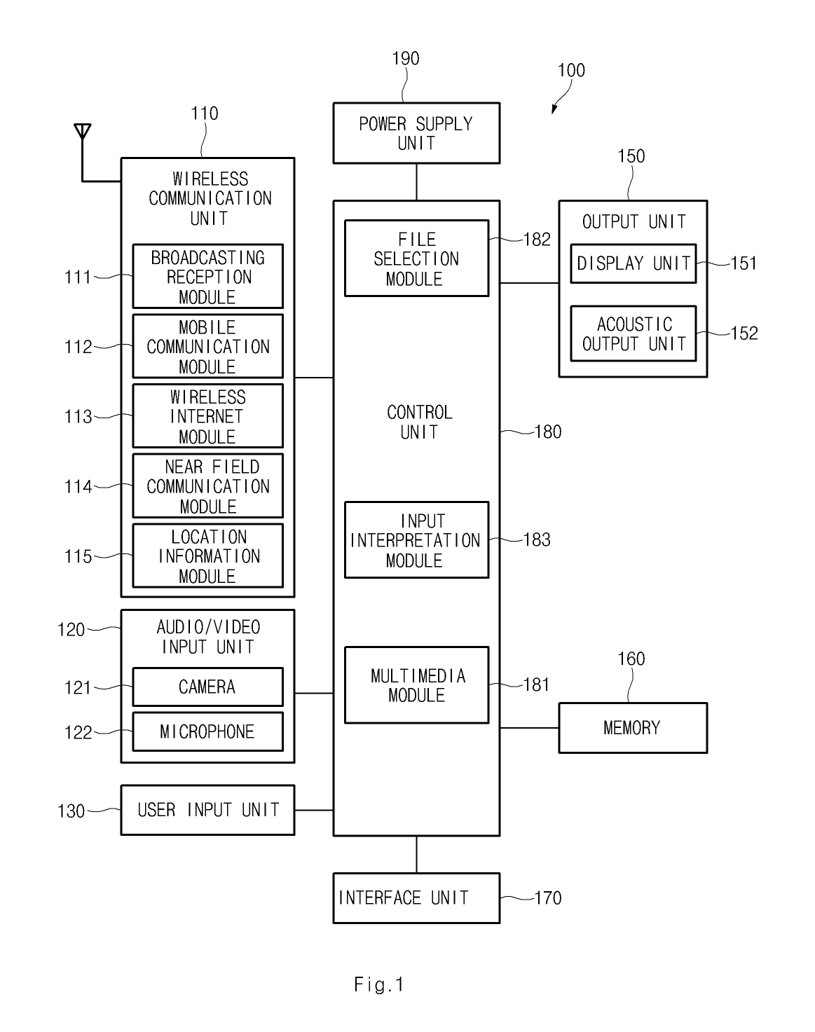

FIG. 1 is a schematic block diagram illustrating a configuration of a mobile device implemented in vehicles which is provided with an album list management system according to an exemplary embodiment of the present invention. Even though the exemplary embodiment of the present invention has been illustrated as being applied to and implemented in a navigation apparatus for vehicles, it is just one example. The mobile device may be a terminal which is mounted in a vehicle or a terminal which is portable or installed in another available device depending upon the user's requirements. The mobile device may be implemented within various types of mobile phones, smart phones, laptop computers, digital broadcasting reception terminals, personal digital assistants (PDAs), portable multimedia players (PMPs), tablet computers, etc.

As shown in FIG. 1, the mobile device implemented in a vehicle according to an exemplary embodiment of the present invention includes a wireless communication unit 110, an audio/video (A/V) input unit 120, a user input unit 130, an output unit 150, a memory 160, an interface unit 170, a control unit 180, and a power supply unit 190.

The wireless communication unit 110 may include at least one module that allows wireless communication between the mobile device 100 and a wireless communication system, or between the mobile device 100 and a network provided in an area in which the mobile device 100 is located. That is, for example, the wireless communication unit 110 may include a broadcasting reception module 111, a mobile communication module 112, a wireless Internet module 113, a near field communication module 114, and/or a location information module 115, etc.

The broadcasting reception module 111 receives a broadcasting signal via an antenna or receives broadcast-related information from an external broadcasting management server via a separate broadcasting channel. The broadcasting channel may include satellite channels and/or terrestrial channels.

The broadcasting management server generates a broadcasting signal and/or broadcast-related information and transmits the generated broadcasting signal and/or the generated broadcast-related information to the mobile device or receives a pre-generated broadcasting signal and/or a pre-generated broadcast-related information and then transmits the received broadcasting signal and/or the received broadcast-related information to the mobile device. In addition, the broadcasting signal may include a broadcasting signal in which the data broadcasting signal is combined with a television (TV) broadcasting signal or a radio broadcasting signal as well as a data broadcasting signal such as the TV broadcasting signal, the radio broadcasting signal, traffic information (for example, transport protocol experts group (TPEG) information).

The broadcast-related information may include broadcasting channels, broadcasting programs or information related to a broadcasting service provider. The broadcast-related information may be received by the mobile communication module 112 through a mobile communication network, or provided in Internet protocol (IP) content formats through the wireless Internet module 113.

The broadcast-related information may exist in various formats. The digital broadcasting signal may be received using a digital broadcasting system such as electronic program guide (EPG) of digital multimedia broadcasting (DMB), digital video broadcast-terrestrial (DVB-T), digital multimedia broadcasting-satellite (DMB-S), media forward link only (MediaFLO), digital video broadcast-handheld (DMB-H), integrated services digital broadcast-terrestrial (ISDB-T). The broadcasting reception module 111 may include the above-described digital broadcasting system. If necessary, the broadcasting reception module 111 may be configured to be suitable for other broadcasting systems of different formats, which are not described above, including analog broadcasting.

The broadcasting signal and/or broadcast-related information received through the broadcasting-reception module 111 may be stored in the memory 160 if necessary.

The mobile communication module 112 receives or transmits a radio signal from or to at least one of a base station, an external terminal, and/or a server on a mobile communication network. The radio signal may include data of various types according to transmission/reception of a sound signal, an image communication signal, or text/multimedia message.

The wireless Internet module 113 is configured for wireless Internet connection. The wireless Internet module 113 may be built into the mobile device 100 or combined with the mobile device 100 in an armoured manner. Furthermore as wireless Internet technology, wireless local area network (WLAN), (Wi-Fi), wireless broadband (Wibro), world interoperability for microwave access (Wimax), high speed downlink packet access (HSDPA), etc. may be used.

The near field communication module 114 is configured to perform short-range communication. As the near field communication module 114, Bluetooth, radio frequency identification (RFID), infrared data association (IrDA), ultra wideband (UWB), ZigBee, etc. may be used.

The location information module 115 is configured to obtain location information of the mobile device 100. For example, a global position system (GPS) module is typically used. A current location may be calculated by integrally computing signals received from the location information module 115. The current location may be displayed on a map through a display unit 151 to be described later. Guidance for a driving direction, a driving speed, and a course may be performed using the current location.

In FIG. 1, the A/V input unit 120 is configured to receive video information and audio information, and may include a camera 121, a microphone 122, etc. The camera 121 generates an image frame such as a still or image, which is obtained by an image sensor in a black box recording mode implemented in the vehicle. The generated image frame may be displayed on the display unit 151.

Meanwhile, the image frame generated from the camera 121 may be stored in the memory 160 or transmitted to an outside receptor through the wireless communication unit 110. Two or more cameras 121 may be provided according to use environments, for example, to perform a multi-channel black box function of shooting images in two directions, forward and rearward directions, or more at the same time.

The microphone 122 is configured to receive external acoustic information in a communication mode, a record mode or a sound recognition mode, etc, convert the received external acoustic information into an electric sound signal and process the electric signal. When in the communication mode, the converted sound signal may be processed into a transmittable form to the mobile communication base station by the mobile communication module 112 and output through the antenna. A user may directly input a destination or starting point through a sound or command to, e.g., calculate a route. The microphone 122 may be implemented with various noise removal algorithms to remove noise generated during receiving the external acoustic signal and analyze only the noise intended to be received by the microphone module 112.

The user input unit 130 is configured to generate input information for controlling an overall operation of the mobile device according to a user's operation. The user input unit 130 may include a key pad, a dome switch, a touch pad (e.g., through static pressure/static electricity or heat sensitivity), a jog wheel, a jog switch, etc.

The output unit 150 is configured to display a result as a signal recognizable by a user through his/her own five senses through a signal processing process contracted by the mobile device 100. The output unit 150 includes a display unit 151 and an acoustic output module 152 which are representative output devices.

The display unit 151 displays the data processed from the mobile device 100 on the screen as visual information. For example, when the mobile device is in the navigation mode, the display unit 151 displays vehicle service-related information such as a current location, a destination and route, map, speed, direction, distance remaining, etc. on the screen, and provides a user interface (UI) related thereto. When the mobile device is in the black box mode or the imaging mode, the display unit 151 provides a recorded image or an UI (or graphic user interface (GUI)).

Meanwhile, the display unit 151 may be embodied as at least one of a liquid crystal display (LCD), a thin film transistor-liquid crystal display (TFT-LCD), an organic light emitting diode (OLED), a flexible display, a three dimensional (3-D) display, a dual play in which different images may be displayed according to a view direction (for example, an output device in which a map is displayed when one display is viewed from a driver seat, and a broadcasting image is displayed when the one display is viewed from a passenger seat).

Some of the above-described various display devices may be implemented as a transparent type or a light transmission type. A transparent organic light emitting diode (TOLED) is typically used as the display device. The rear side of the display unit 151, that is, a rearward structure may be also implanted in the light transmission type. By such a structure, the user can view an object placed behind the body of the mobile device or the vehicle through an area in which the display unit 151 of the body of the mobile device is occupied.

In addition, two or more display units 151 may be disposed according to an embodied type of the mobile device 100. For example, a plurality of display devices may be arranged to be spaced apart from each other on one surface, or may be integrally disposed. The plurality of display devices may be separately arranged on different surfaces as well.

When the display unit 151 and a sensor (hereinafter, referred to as a ‘touch sensor’), which senses a touch operation of the user have a layered structure, the display unit 151 can also be used as an input device as well as an output device. For example, the touch sensor may have various types such as a touch film, a touch sheet, or a touch pad.

The touch sensor is configured to convert a change of a pressure or a static capacitance applied to a special area of the display unit 151 into an electric input signal. The touch sensor is configured to detect the pressure, static or heat at a touch as well as a touched location and a touched area.

When there is a touch input to the touch sensor, a signal corresponding to contact is generated and transmitted to a touch controller (not shown). The touch controller transmits data in which the signal is processed to the control unit 180. Thereby, the control unit 180 recognizes which area of a display panel is touched.

Hereinafter, for clarity, an action of recognizing a state in which a pointer is located on the touch screen while the pointer is not directly contacted with the touch screen and approaches the touch screen, is referred to as a “proximity touch”, and an action in which the pointer is in substantial contact with the touch screen, is referred to as a ‘contact touch’. On the touch screen, the location becoming the proximity touch on the touch screen with the pointer is designated as a location at which the pointer is perpendicular to the touch screen when the pointer approaches the touch screen. In addition, the touch screen may sense touch signals simultaneously applied to two or more points, and this is referred to as a ‘multi-touch’.

Meanwhile, the acoustic output module 152, in a multimedia file playback mode, a broadcasting reception mode, etc, may output audio data, received from the wireless communication unit 110 or stored in the memory 160. The acoustic output module 152 outputs acoustic information related to a function, which is performed in the mobile device 100 (such as, an alarm sound, a notification sound, a course guidance sound, etc.). The acoustic output module 152 may include a receiver, a speaker, a buzzer, etc.

The memory 160 is configured to store a program to process the data of the control unit 180 and to control the control unit 180, retain content material such as telephone directory, map information, audio and video information as data, and temporarily store data which is input or output through the user input unit 130 or an output unit 150.

The memory 160 may also store use frequency for each data (such as frequent destination, or use frequency to each multimedia file). The memory 160 may also store data related to vibrations and sounds of various patterns, which are output when a touch input is input on the touch screen.

The memory 160 may include any one type of storage medium of a flash memory type, a hard disk type, a multimedia card micro type, a card type such as a secure digital (SD) card or an extreme digital (XD), a random access memory (RAM), a static random access memory (SRAM), a read only memory (ROM), an electrically erasable programmable read only memory (EEPROM), a programmable read only memory (PROM), a magnetic disk, and light disk. Additionally, the mobile device 100 may be configured to interwork with the web storage executing a data storage function of the memory 160 on Internet.

The interface unit 170 performs a channel function to all external devices connected to the mobile device 100. The interface unit 170 receives data or power from the external devices and transmits the received data or power to each component in the mobile device 100. The interface unit 170 functions to transmit the processed data in the mobile device 100 to the external devices. The interface unit 170 may include a wired/wireless headset port, an external charger port, a wired/wireless data port, a video input/output (I/O) port, an earphone port, etc.

When the mobile device 100 is connected with an external cradle, the interface unit 170 may function as a channel through which the power supplied from the cradle is supplied to the mobile device 100 or through which various command signals inputted from the cradle by the user are transmitted to the mobile device 100. The various command signals or the power may be used for a signal to recognize a state in which the mobile device 100 is precisely installed to the cradle.

The control unit 180 is configured to control an overall operation of the mobile device 100. The control unit 180 performs control for data communication, course detection, black box recording, etc and data processing. The control unit 180 includes a multimedia module 181 for multimedia reproduction.

In addition, the control unit 180 includes a file selection module 182 and an input interpretation module 183. The file selection module is configured to select which type of files input through, e.g., the wireless communication unit 110, the A/V input unit 120, or the interface unit 170 and store the file in an album type in which the file is classified for each type accordingly in the memory 160. The input interpretation module 183 is configured to interpret a signal inputted through the touch sensor according to the predetermined criterion and to convert the interpreted signal into a corresponding command.

The multimedia module 181, the file selection module 182, and the input interpretation module 183 are not necessarily implemented in the control unit 180. The multimedia module 181, the file selection module 182, and the input interpretation module 183 may be implemented separately from the control unit 180 without departing from the overall invention.

The control unit 180 may analyze various input patterns such as a writing input or a drawing input performed on the touch screen through the input interpretation module 183, and process a pattern recognition process of recognizing the input as a letter or an image.

The power supply unit 190 supplies operation power to the whole device under control of the control unit 180.

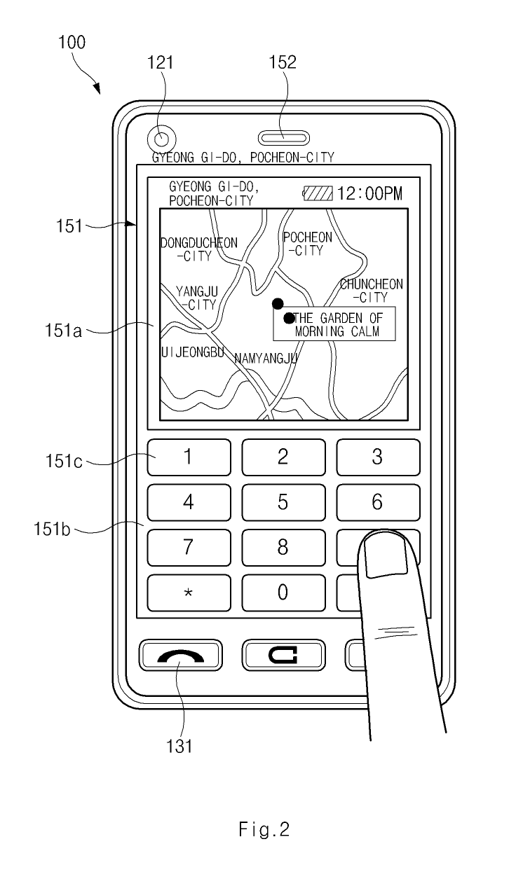

FIG. 2 is a view illustrating an operation of the mobile device 100 according to an exemplary embodiment of the present invention. Although the mobile device 100 is provided with a bar shaped body is illustrated in FIG. 2, other various structures such as a slide type, a folder type, a swing type, a swing ball type, etc. in which two or more bodies are combined may be applied thereto.

The body of the mobile device may include a case (casing, housing, cover, etc.) which provides an outward protective appearance. The case may be made of plastic resin by an injection moulding method or may be made of metal materials such as stainless steel (STS) or titanium (Ti).

The display unit 151, the acoustic output unit 152, the camera 121, the user input unit 130, the microphone 122, the interface unit 170, etc. may be disposed in the body of the mobile device 100.

The display unit 151 occupies most of a main surface, that is, a front surface of a front case. The acoustic output module 152 and the camera 121 are disposed at the upper portion of the display unit 151, and the input button 131 and the microphone 122 are disposed at the lower portion of the display unit 151. Other input device of the user input unit 130 and the interface unit 170, etc. may be disposed at a lateral surface of the front case and/or a rear case.

The user input unit 130 is configured to receive command for controlling an operation of the mobile device 100 from the user. The user input unit 130 may include a plurality of manipulation units. The plurality of manipulation units are generally called as a manipulation portion. Any tactile manner may be employed.

The contents inputted by the manipulation units may be variously set. For example, a first manipulation unit may receive commands such as start, end and scroll and a second manipulation unit may receive commands such as intensity adjustment of sound outputted from the acoustic output module 152 and conversion into a touch reorganization mode of the display unit 151.

The display unit 151 may display various kinds of the visual information. The information may be displayed in various forms of letters, figures, signs, graphics, icons, and etc. These are fixedly arranged to be displayed in a keypad form so that the user may input corresponding information by selecting and touching a desired character. This is referred to as a “virtual keypad”.

FIG. 2 shows a process of inputting information by a user through a touch input applied to the visual keypad provided on a front window of the mobile device. The display unit 151 operates as the whole area or as a plurality of divided areas. In the latter case, the plurality of divided areas are configured to operate to be involved with each other.

For example, at each of the upper and lower portions of the display unit 151, an output window 151a and an input window 151b are arranged. A visual keypad 151c in which numbers for inputting the address/house number are displayed is outputted in the input window 151b. When the visual keypad 151c is touched, the number, etc. corresponding to the touched point are displayed on one side area of the output window 151a.

In addition, the touch pad implemented in a layered structure with the display unit 151 may recognize a touch input by scrolling and perform processing corresponding to the recognized touch input.

The user may move an entity (such as cursor or pointer located on an icon, etc.) displayed on the display unit 151 by scrolling the touch pad on the display unit 151. In addition, when the user moves her or his finger on the touch pad of the display unit 151, the course according to movement of the finger is visually displayed on the display unit 151. This is usefully used in editing an image being displayed on the display unit 151. The display unit 151 shown in FIG. 2 may be implemented with the touch screen provided with the above-described function.

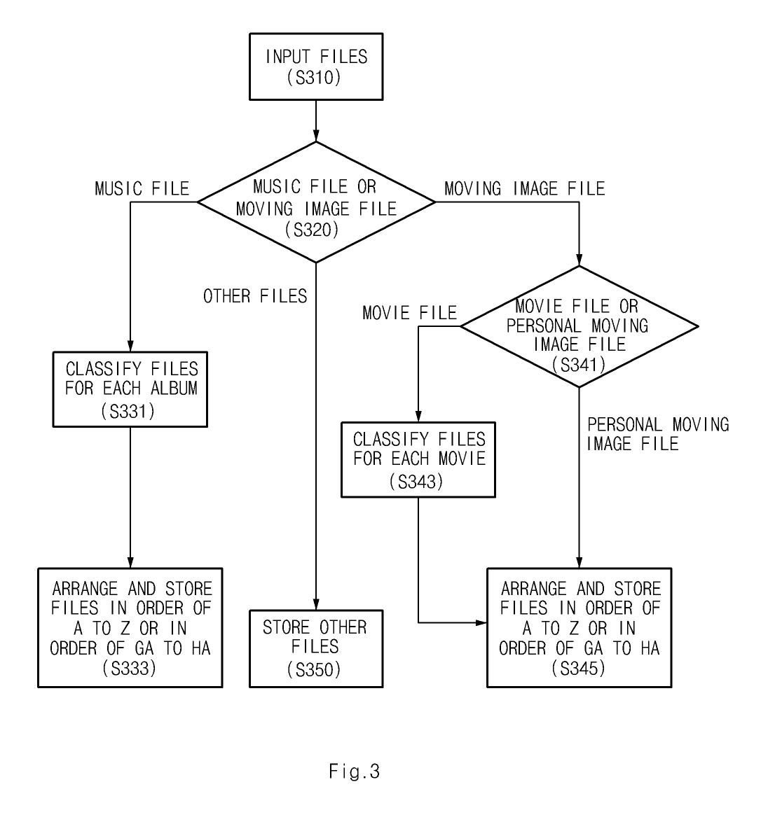

Hereinafter, an operation of the mobile device having the above-described configuration will be described with reference to a flow chart of FIG. 3.

FIG. 3 illustrates one of file classification methods according to an exemplary embodiment of the present invention. A user may input files through an input device provided in the terminal, that is, the wireless communication unit 110, the A/V input unit 120, or the interface unit 170.

When a file input is sensed from any one of the above-described input channels (S310), the file selection module 182 in the control unit 180 divides and determines whether the corresponding file is a music file, moving image file, or other general file based on extension of the input file and/or control information stored in the file (S320).

As a result, when it is confirmed that the corresponding file is a music file, the file selection module 182 classifies the input file for each album using information for an album stored in the corresponding file (S331). At this time, when the information for the album is not recorded in the file, the control unit 180 may access a server or a network through the wireless communication unit 110 and collect the information about the album. A process of collecting the album information may include executing a search based on information such as a file name of the file. In addition, various methods and technologies disclosed in the field may be used.

After the music file is classified for each album through the above-described process, the file selection module 182 of the control unit 180 arranges the file in, e.g., alphabetical order from “A” to “Z” in the English alphabet, or “Ga” to “Ha” in the Korean alphabet, based on a name of each album and stores the file in the memory 160, thereby managing the file (S333).

When it is confirmed that the input file is a moving image file as a file selection result in step S320, the file selection module 182 determines whether the corresponding file is a movie file or a personal moving image file based on moving image information included in the corresponding moving image file (S341). At this time, when the corresponding file does not include moving image information, the control unit 180 may be configured to collect information for the corresponding image through the wireless communication unit 110.

When the input file is classified into a movie file through the above described process, the file selection module 182 classifies the corresponding movie file by each title, each leading actor, or each movie director (S343). The file selection module 182 then arranges the movie file in order alphabetical order based on a name of each item, stores the file in the memory 160, and manages the movie file in an album format (S345).

When the input file is classified into neither a movie file nor a moving image file as a file selection result in the step S320, the file selection module 182 stores the corresponding movie file in a position designated by the user or a preset position within the terminal (S350).

The terminal device 100 may be configured to automatically execute the above-described process by the control unit 180 when the file is input to the mobile terminal 100. Alternatively, the terminal device 100 may be configured to manually classify and arrange the files and stored the file in a predetermined area of the memory 160 by the user through the control unit 180 if necessary.

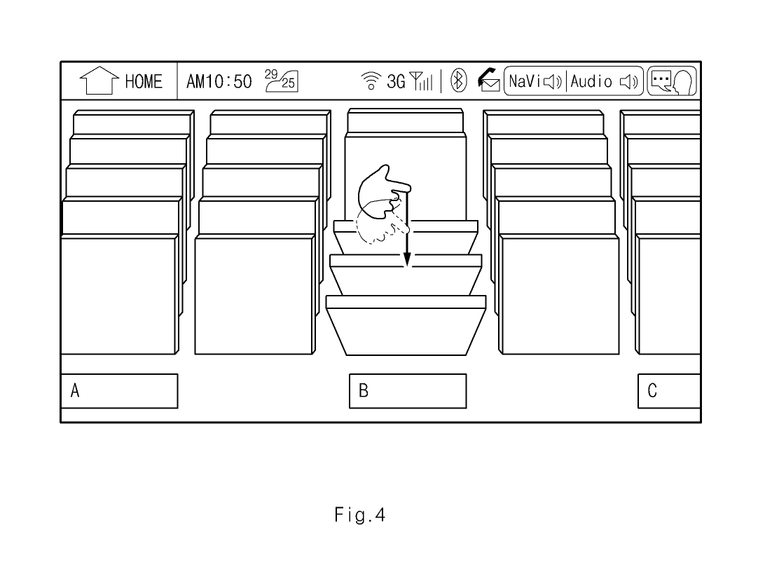

Subsequently, a process of reproducing the file which is arranged and managed by the above-described process will be described. FIG. 4 illustrates an example of an index item search method according to an exemplary embodiment of the present invention.

As shown in FIG. 4, the control unit 180 may arrange and display a list of albums arranged by the above-described process on the display unit 151. As described above, a touch screen may be included in the display unit 151 in a layered structure. In this embodiment, the user may flick the touch screen to search or select a desired file among the album list displayed on the display unit 151. The term flick denotes an operation that the user flicks a touch input on the touch screen by a pointer.

Referring to FIG. 4, the albums are arranged in the album list in alphabetical order based on an album title. That is, the album list is arranged in a row. Albums of which titles begin with the letter “A” are sequentially arranged in the row A, and Albums of which titles begin with the letter “B” are sequentially arranged in the row B. Adjacent albums are represented in a partially overlapping manner.

The user may select the row of the album list by flicking the touch screen left and right in the state that the album list is displayed on the display unit 151. The row on the album list denotes a set of albums arranged as the same index (for example, albums of initials begin with alphabet “A” are arranged in the same row.). At this time, each album list may be displayed not in a simple text type, but an image type of an album case. Therefore, the user confirms the album list not by the type of text information for a corresponding album, but by album artwork of image information and thus the user can select a row of the album list including the album to be selected by the user fast and accurately.

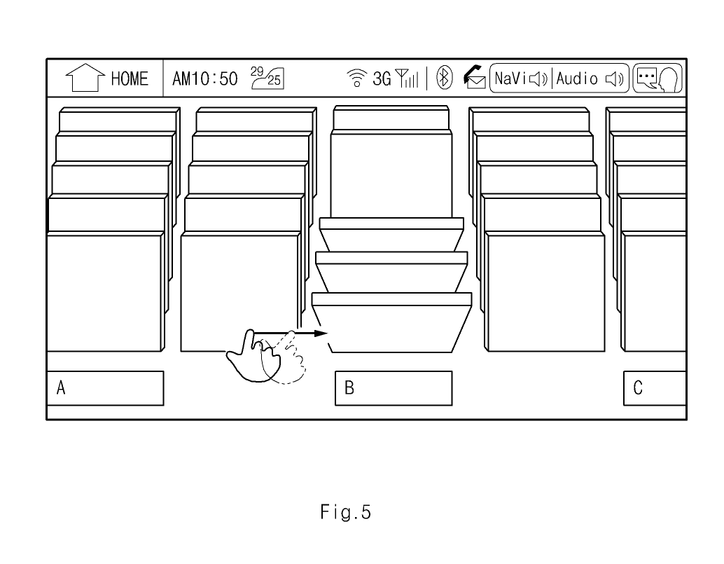

FIG. 5 is a view illustrating an example of a sequenced item search method according to an exemplary embodiment of the present invention. As described in FIG. 4, after the user select the row of the album list including a desired album by a flicking manner, the user may select the desired album in the selected row of the corresponding album list. For example, when an album to be listened by the user is in a row B, the user flicks the touch screen in the row B from a top to bottom direction to select the album. That is, when the user flicks the touch screen from the top side of the row B toward the bottom side of the row B or from the bottom side of the row B toward the top side of the row B using a pointer (his/her finger), while the albums sequentially arranged in the row B are sequentially turned over to the top side direction or a bottom side direction one by one, the user selects the corresponding album at the point of time when a album artwork of the desired album is exhibited in front of the user. Therefore, the user can index and select the desired album on the list. The method of FIG. 5 may be used separately from the method of FIG. 4.

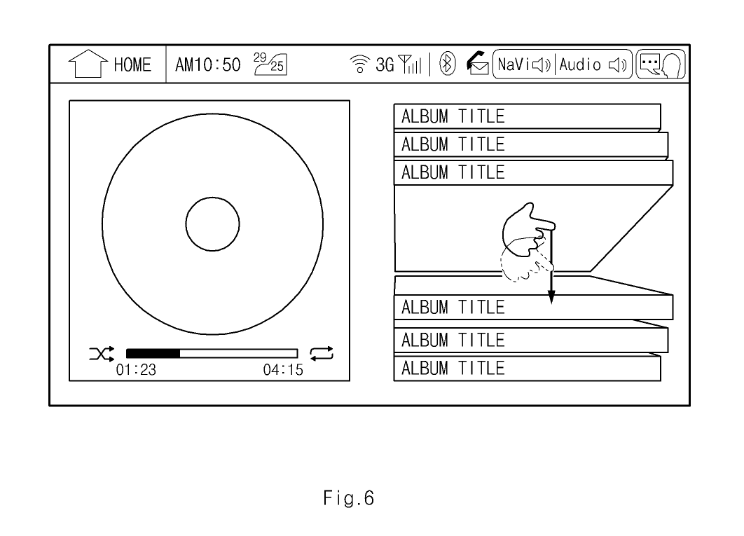

FIG. 6 illustrates an example of an image output on a display screen when a specific album is selected by the above-described process. In FIG. 6, a first area of the display unit 151 may display a album artwork of an album or a compact disc (CD) image of the album and a second area may display an album list. That is, an album selected by the user and being reproduced (played) is displayed in the first area to represent a current reproduction state and the lists of albums in a non-reproduction state are arranged and displayed in order of title of an album in the second area.

When the user flicks the album lists in the top and bottom direction, the album list is turned over from the top side toward the bottom side or from the bottom side toward the top side and a album artwork of a corresponding album is displayed to the user. Therefore, even when reproducing a music file of the specific album, the user flicks the album list in the top and bottom direction implemented in the second area to select another album.

The method of FIG. 6 may be used with the methods illustrated in FIGS. 4 and 5. That is, when the user indexes (searches) a desired specific album through left and right flick or top and bottom flick and then execute a long touch input on the corresponding album by a pointer, the screen illustrated in FIG. 4 or 5 is switched the screen illustrated in FIG. 6. Of course, the user may select the desired album in the album list only through the screen of FIG. 6 without the processes of FIGS. 4 and 5.

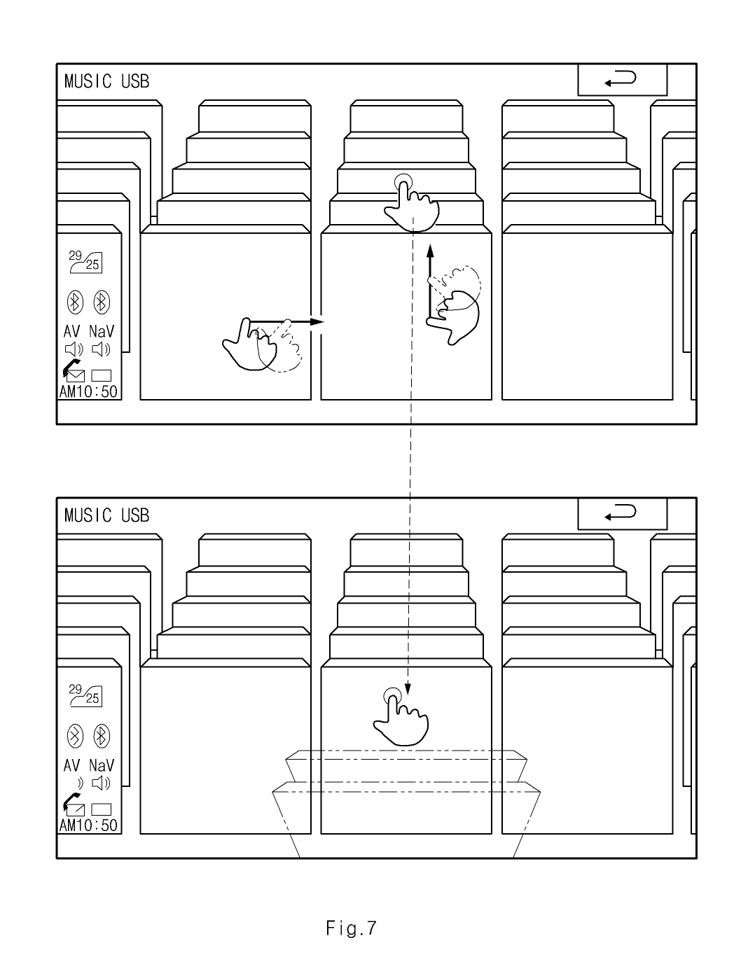

FIG. 7 is a view illustrating a case where the methods of FIGS. 4 and 5 simultaneously used. As shown in FIG. 7, the user may index a row of an album list through left and right flick and find a specific album in a corresponding a row through top and bottom click. In a state that the specific album is searched, the user may apply a long touch input to the touch screen to select the corresponding album and thus the screen of the display unit 151 is switched to the screen shown in FIG. 6.

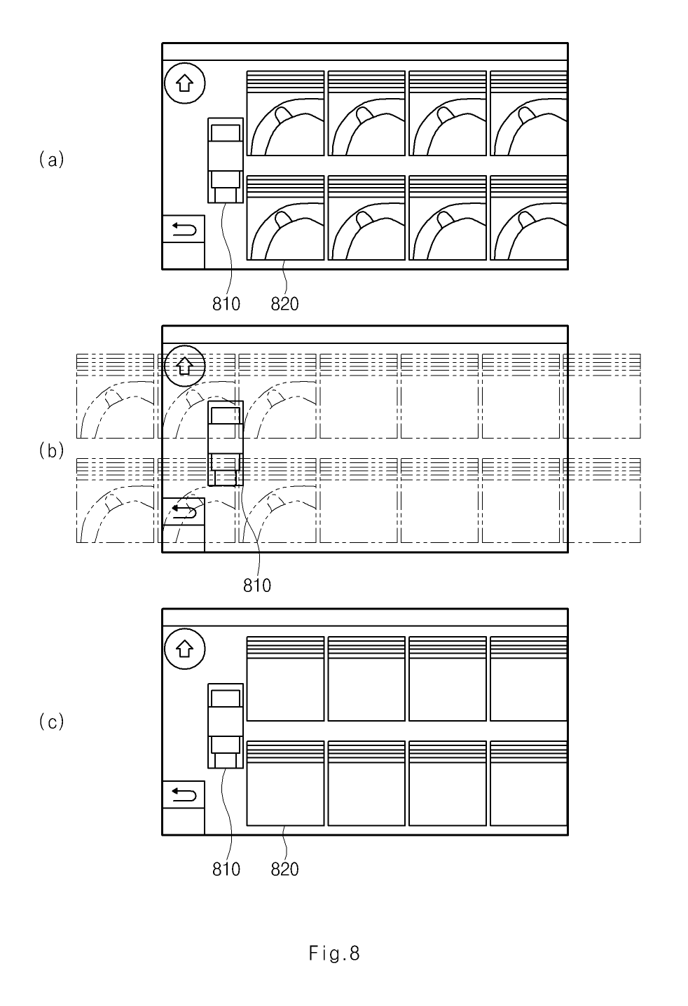

FIGS. 8A to 8C illustrate another example of an index item search method according to another exemplary embodiment of the present invention. As shown in FIGS. 8A to 8C, a row of the album list is configured of two stages. Although the case where the row of the album list is arranged in order of alphabet “A” to alphabet “Z” or in order of Korean alphabet “Ga” to Korean alphabet “Ha” is illustrated in FIG. 4, the album list may be implemented with only a album artwork of each album in FIG. 8.

At this time, when the user flicks the touch screen in a left and right direction in FIG. 8A, corresponding images are changed as shown in FIG. 8B and then switched to a screen of FIG. 8C.

Further, in FIGS. 8A to 8C, the display unit 151 may be divided into a third area 810 in which the row of each album is selected in the top and bottom direction and a fourth area 820 in which other album lists are displayed on the basis of an album case located in the center portion of the third area 810.

For example, the user flicks from a top side of the third area toward a bottom side of the third area or from the bottom side of the third area toward the top side, images of album cases included in an album list are sequentially changed in a flicking direction. When a album artwork of a specific album desired by the user is arranged in the center portion of the third area through the above-described process, album artworks of remaining albums is displayed in the fourth area on the basis of the album artwork of the specific album.

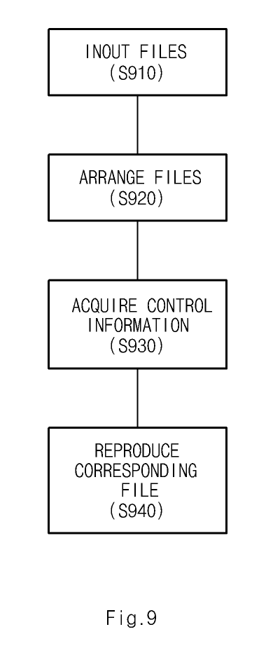

FIG. 9 is a sequence diagram illustrating a process of inputting files to the mobile terminal 100, automatically classifying the files, and reproducing the files, in which the above-described processes are integrated, according to an exemplary embodiment of the present invention. Referring to FIG. 9, the mobile terminal 100 may input files through the wireless communication unit 110, the A/V input unit 120, or the interface unit 170 as in the file input step S310 of FIG. 3 (S910).

The file selection module 182 of the control unit 180 analyzes the input files and divides the input files into a music file, a video file (still image/moving image file), and other general files, divides the video file into a movie files and the personally made moving image files, arranges the files in an album list format based on the desired criterion, and stores the album list in the memory 160 (S920).

Hereafter, when the user selects a multimedia function, the control unit 180 display the album list arranged by the above-described process on the display unit 151. Subsequently, when the user inputs control information through the touch screen by a flicking method as shown in FIGS. 4 to 8C to select a specific album in the album list, the input interpretation module 183 of the control unit 180 acquires the control information based on an operation such as flicking executed by the user (S930).

The control unit 180 interprets the control information and scroll the album list in the top and bottom direction or perform control of executing reproduction (play) (S940). That is, according to the exemplary embodiments, the files input to the mobile device can be automatically classified in accordance with the type thereof and arranged and managed at a glance. The included files can be displayed on a display screen in an album list format which is intuitively recognizable upon the user's demand, and the file desired by the user can be quickly and easily found and reproduced through the user's simple manipulation. Therefore, a useful user interface which can conveniently be use a mobile device can be provided to the user without fear of accident occurring when moving or driving.

The present invention is not limited to the exemplary embodiments and may be variously modified and implemented without departing from the spirit and scope of the present invention. The present invention may be implemented by combining all exemplary embodiments or selectively combining some of the exemplary embodiments.

The above-described exemplary embodiments may be implemented within a computer- or computer-similar apparatus-readable recording medium, for example, using software, hardware, or a combination thereof. Through hardware implementation, the present invention may be implemented using any one of application specific integrated circuits ASICs (ASICs), digital signal processors (DSPs), digital signal processing devices (DSPDs), programmable logic devices (PLDs), field programmable gate arrays (FPGAs), processors, controllers, microcontrollers, microprocessor, and electronic units to perform other functions.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An album list management method for managing files in a mobile device, the method comprising:
inputting, by an input unit in the mobile device, files from an outside source;
classifying the input files according to types of the files and storing the classified files in a memory;
generating, by a control unit, an album list to be displayed for each classified file; and
displaying the generated album list on a display unit.

2. The method of claim 1, wherein the classifying and storing the files includes selectively classifying the input files into a video file and a music file and storing the classified files.

3. The method of claim 1, wherein the classifying and storing the files includes classifying the input files based on extension of the input files or a result searched through a network connectable to a terminal.

4. The method of claim 1, wherein the album list is implemented with a album artwork of a corresponding album.

5. The method of claim 1, wherein the display unit includes an input device in which information is inputted through contact,
the method further comprising flick-controlling the album list by a flick signal from a first reference point to a second reference point through the input device.

6. The method of claim 5, wherein the flick-controlling the album list includes controlling left and right scroll of the album list by lateral directional flicking and controlling top and bottom scroll of the album list by longitudinal directional flicking.

7. The method of claim 5, wherein the flick-controlling the album list includes, with respect to an arbitrary album on the album list, performing a long touch on the display unit of the album to execute reproduction of the album.

8. An album list management system in a mobile terminal, the system comprising:
an input device configured to input files from the outside;
a memory configured to store the files input through the input device; and
a control unit configured to classify the files input through the input device for each type of the file and store the classified files in the memory.

9. The system of claim 8, further comprising a display unit configured to arrange a music file or a video file stored in the memory in a list of an album image type according to control of the control unit and display the list on a screen.

10. The system of claim 8, wherein the input device includes any one selected from the group consisting of a wireless communication unit configured to perform connection to a wireless communication system, an audio/video (A/V) input unit configured to receive external video information or external audio information, and an interface unit configured to connect with an external apparatus.

11. The system of claim 9, wherein the display unit includes an input device configured to input information through contact, and
the control unit include a file selection module configured to select the files inputted into the terminal by each type of the file, and an input interpretation module configured to control scroll of the album list based on a flick signal from a first reference point to a second reference point through the input device.

12. A storage medium containing executable program instructions executed by a processor, comprising:
program instructions that input files from the an outside source;
program instructions that classify the input files according to types of the files and storing the classified files in a memory;
program instructions that generate an album list to be displayed for each classified file; and
program instructions that display the generated album list on a display unit.

13. The storage medium of claim 12, wherein the program instructions that classify and store the files further include program instructions that selectively classify the input files into a video file and a music file and storing the classified files.

14. The storage medium of claim 12, wherein the program instructions that classify and store the files further include program instructions that classify the input files based on extension of the input files or a result searched through a network connectable to a terminal.

15. The storage medium of claim 12, wherein the album list is implemented with album artwork of a corresponding album.

16. The storage medium of claim 12, further comprising program instructions that allow for flick-controlling the album list by a flick signal from a first reference point to a second reference point through the input device.

17. The storage medium of claim 16, wherein the program instructions for flick-controlling the album list includes program instructions that control left and right scroll of the album list by lateral directional flicking and controlling top and bottom scroll of the album list by longitudinal directional flicking.

18. The storage medium of claim 16, wherein the program instructions for flick-controlling the album list includes program instructions that perform, with respect to an arbitrary album on the album list, a long touch on the display unit of the album to execute reproduction of the album.
